(19) United States
(12) Patent Application Publication
(10) Pub. No.: US 2026/0147557 A1
(43) Pub. Date: May 28, 2026

(54) PERSONALIZED ONBOARDING AND PRODUCT CONFIGURATION

(71) Applicant: INTUIT INC., Mountain View, CA (US)

(72) Inventors: Jingyuan ZHANG, Mountain View, CA (US); Shankar SANKARARAMAN, Mountain View, CA (US); Zhewen FAN, Mountain View, CA (US)

(73) Assignee: INTUIT INC., Mountain View, CA (US)

(21) Appl. No.: 18/963,189

(22) Filed: Nov. 27, 2024

(51) Int. Cl. G06F 8/61

(52) U.S. Cl. CPC G06F 8/63

(57) ABSTRACT

At least one processor can receive user data indicating a user attempt to access a software product. The at least one processor can determine a user type from the user data, which can include selecting the user type as one of at least a new user and a returning user. The at least one processor can select a set of a plurality of machine learning (ML) models corresponding with the user type with which to process the data, wherein at least two separate sets of the plurality of ML models are separately configured to collectively predict a specific set of software product elements. The at least one processor can use the selected ML models to predict at least a subset of the specific set of software product elements for the user and configure the software product to include the predicted subset of software product elements upon user access.

### BACKGROUND

Software user interfaces (UIs) often attempt to provide customized experiences to users. For example, consider a software as a service (SaaS) product that is used infrequently, such as an annual service provider like a tax preparation service. Users login and then go through an onboarding process where they answer a series of questions, after which the product can offer recommended services that are, in theory, customized to the user. The onboarding process is often generic and does not take into account each customer's unique preferences, characteristics, and behavior. This results in a high rate of customer churn at onboarding, as customers do not feel engaged or understood by the product. Furthermore, when customers return to the product, they are often presented with the same generic onboarding process, which can be frustrating and unappealing.

To the extent attempts have been made to solve the churn problem for such products, they generally have technical shortcomings. For example, Some automated onboarding systems such as Sana use machine learning (ML) techniques to personalize the onboarding experience. In general, these systems build customer segments and predict user behavior, allowing them to personalize the onboarding experience based on each user's unique needs and preferences. However, these systems do not differentiate between user types when determining what ML techniques or models to apply. Solutions that work well for returning users, who have used the product before, can often underperform for new users attempting to use the product for the first time, and in similar fashion, solutions that work well for new users can often frustrate returning users. Moreover, returning users can have profiles from which data can be pre-populated, but this can obscure changes in the returning user's situation that have occurred since the most recent previous use of the product. Tracking new user clickstream data and comparing it with clickstream data of like users is a known approach for customizing interfaces for new users, but it can fall short when the customization is geared toward providing features that do not necessarily relate to real-time activity, such as a user's situation over the past year in a tax example.

### BRIEF DESCRIPTIONS OF THE DRAWINGS

FIG. 1 shows an example personalized onboarding and product configuration system according to some embodiments of the disclosure.

FIG. 2 shows an example system setup and deployment process according to some embodiments of the disclosure.

FIG. 3 shows an example personalized onboarding and product configuration process according to some embodiments of the disclosure.

FIG. 4 shows an example personalized onboarding and product configuration process according to some embodiments of the disclosure.

FIG. 5 shows an example computing device according to some embodiments of the disclosure.

### DETAILED DESCRIPTION OF SEVERAL EMBODIMENTS

Systems and methods described herein can improve onboarding user experience and success while also providing robust and effective automatic UI customization that is flexible for a variety of user data completeness levels and predicted scenarios. To accomplish these goals, disclosed embodiments can automatically collect user data prior to an onboarding process and select appropriate program flows and/or ML models or other evaluation techniques to employ depending on the data collected. Accordingly, the disclosed embodiments can effectively onboard and set up customized UIs whether the user of the UI is a returning user with rich data available or a new user without preexisting historical data.

For example, systems and methods described herein can analyze user data and determine a user type (e.g., a new user or a returning user) from the user data. The user data can be processed by multiple ML models (e.g., a separate ML model for each UI element, fillable form, procedure, etc.). Different ML models can be used for the different types, so that, for example, a new user's data will be processed by one ML model and a returning user's data will be processed by a different ML model per topic. The respective ML models may have been trained using different training data sets. Based on the ML processing, the disclosed embodiments can predict a subset of available UI elements or other software product elements that the user is likely to need and can pre-configure a software product to have such features upon user access (e.g., after login or initial onboarding). As a specific, non-limiting example, some embodiments can be used when onboarding users of a tax preparation product, where the product is used infrequently (e.g., annually), and where the onboarding benefits from accurate predictions of a user's tax situation so that appropriate forms or UI elements can be ready as soon as the user logs in. Returning users can have existing profiles, but they may have experienced life changes, while new users have relatively scant data upon which to base predictions. In either case, the disclosed systems and methods can successfully predict user requirements, improving onboarding from a user perspective and improving the automated UI setup process from a technical perspective.

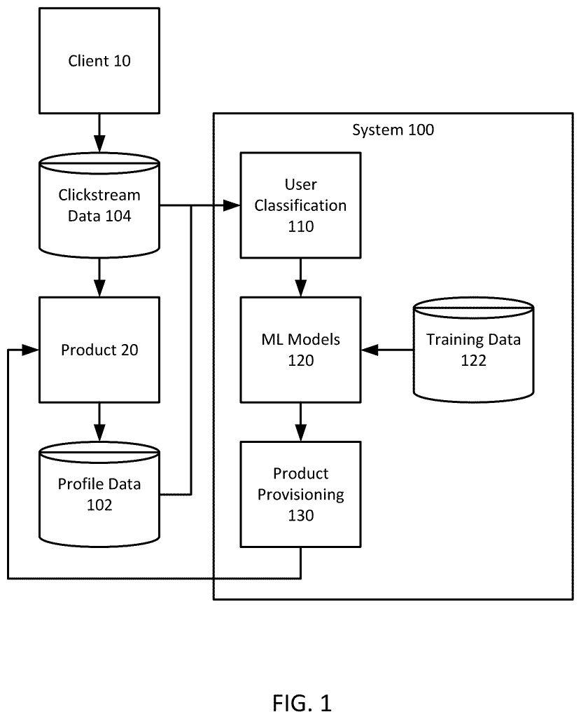

FIG. 1 shows an example personalized onboarding and product configuration system 100 according to some embodiments of the disclosure. System 100 may include a variety of hardware, firmware, and/or software components that interact with one another and/or with external components, such as client 10 and/or product 20. The components of system 100 can include, for example, user classification module 110, ML models 120, and/or product provisioning module 130. System 100 can use data from a variety of sources, such as profile data 102, clickstream data 104, and/or training data 122, as described in detail below. While not illustrated as such, product 20 may be included within system 100 in some embodiments. These elements are described in greater detail below, but in general, a user of client 10 can interact with product 20, which may generate clickstream data 104 during ongoing interaction, and/or which may have generated stored profile data 102 during previous interactions. User classification module 110 can determine whether the user is new or returning by processing profile data 102 and/or clickstream data 104, and by this determination, select ML models 120 suitable for the user. System 100 can process the profile data 102 and/or clickstream data 104 using the selected ML models 120 to determine what product options are appropriate for the user. Product provisioning module 130 can provision product 20 with the appropriate options, even prior to user login and/or onboarding in some embodiments. In some embodiments, system 100 and/or some other process can train ML models 120 on training data 122 that may include, for example, sample clickstream data and/or profile data.

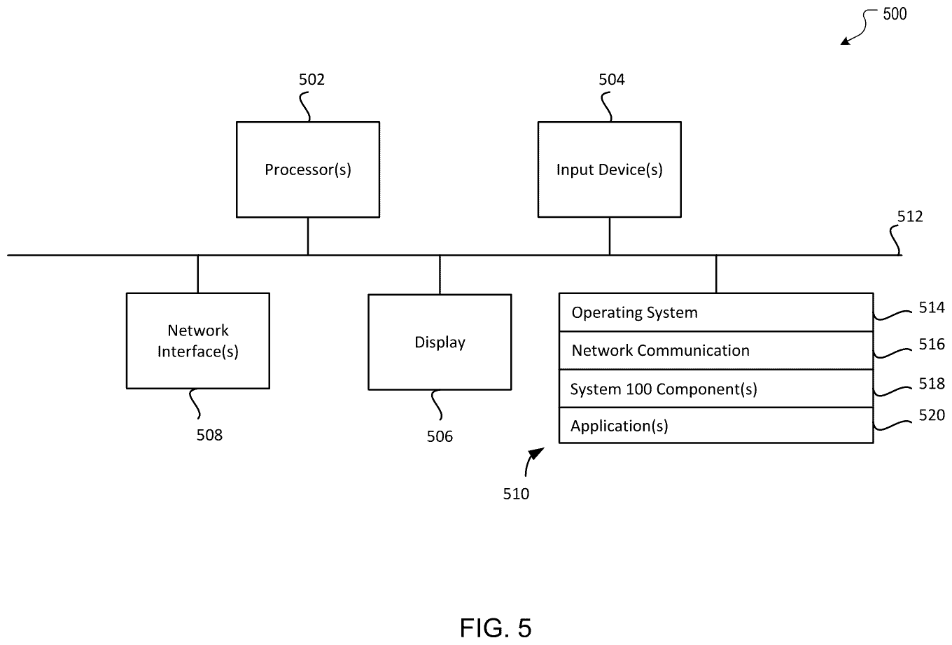

Some components within system 100 may communicate with one another using networks and/or locally. Some components may communicate with external components, such as client 10 and/or product 20, through one or more networks (e.g., the Internet, an intranet, and/or one or more networks that provide a cloud environment) and/or by other modes of data transfer. Each component may be implemented by one or more computers (e.g., as described below with respect to FIG. 5).

Elements illustrated in FIG. 1 (e.g., system 100 (including user classification module 110, ML models 120, and/or product provisioning module 130), client 10, and/or product 20) are each depicted as single blocks for ease of illustration, but those of ordinary skill in the art will appreciate that these may be embodied in different forms for different implementations. For example, while client 10, product 20, and system 100 are depicted separately, any combination of these elements may be part of a combined hardware, firmware, and/or software element. Likewise, while various elements such as user classification module 110, ML models 120, and product provisioning module 130 are depicted as parts of a single system 100, any combination of these elements may be distributed among multiple logical and/or physical locations. Also, while one client 10, one product 20, and one system 100 are illustrated, this is for clarity only, and multiples of any of the above elements may be present. In practice, there may be single instances or multiples of any of the illustrated elements, and/or these elements may be combined or co-located.

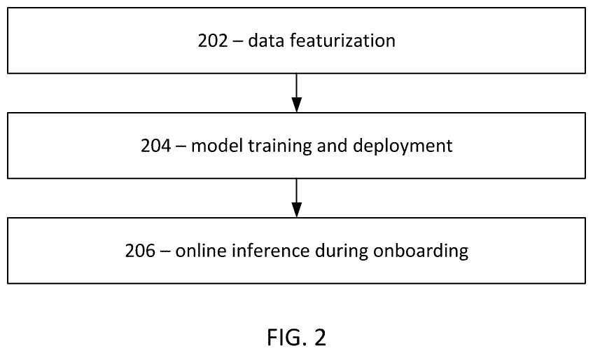

As described in detail below, system 100 can perform processing to automate onboarding of users of client 10 to product 20 and improve automated configuration of product 20. For example, FIGS. 2-4 illustrate the functioning of the illustrated components in detail.

In the following descriptions of how system 100 functions, several examples are presented. However, those of ordinary skill in the art will appreciate that these examples are merely for illustration, and system 100 and its methods of use and operation are extendable to other application and data contexts.

FIG. 2 shows an example system setup and deployment process 200 according to some embodiments of the disclosure. By performing process 200, system 100 can be configured to perform automatic, personalized onboarding and product 20 configuration as shown in detail in subsequent figures.

At 202, system 100 can perform data featurization, for example to build training data 122. Data featurization processing can capture data from pre-login behavior and past attributes of one or more users interacting with product 20. Data featurization processing can be configured with the understanding that one set of ML models 120 can be used to predict product 20 needs for new users, and a different set of ML models 120 can be used to predict product 20 needs for returning users. ML models 120 can predict product 20 needs according to predicted attributes and/or life changes for a user, but because the nature of available data for new users is different from that of available data for returning users, respective ML models 120 can benefit from being trained differently. Accordingly, system 100 can obtain separate training data 122 for both sets of ML models 120, with one portion of training data 122 including new user features, and another portion of training data 122 including returning user features.

For new users, system 100 can derive visitor-level features through tracking their behavior interacting with product 20 before they log in. The behavior can be represented by clickstream data 104, which can include clickstreams of behavior on a site or interface provided by product 20 and/or a source by which they came to product 20. Clickstreams can be captured by any known or proprietary clickstream tracking technique. For example, when a user visits a site provided by product 20, a visitor level ID may be associated with activity performed by the user during the visit. Every time the user clicks something, the click can be tracked (e.g., number of clicks on a given page, which pages visited, which buttons visited, number of clicks of certain buttons on certain pages, etc.), and system 100 can group the user's click information by visitor ID. External marketing campaign data can come from click through source data defining a source from which the user navigated to the page.

Source information can include, for example, a URL or link from which client 10 navigated to a website or other component of product 20, which could indicate, for example, an external marketing campaign that brought the user to product 20. To derive training data 122 labels for new customers, system 100 can extract customer attributes and life changes from the answers of previous-year new customers'onboarding questions presented by product 20 through a UI shown to the user on client 10, for example. Labeling the training data with the customer attributes and life changes can provide ground truth for the ML models 120. Labeled training data 122 for new users can therefore form a first training data set comprising clickstream data generated within product 20 prior to a login stage of operation of product 20.

For returning customers, system 100 can derive features from stored historical information such as profile data 102. In some cases, such as a tax preparation product 20 example, the stored data can include detailed information from fully filled tax forms. System 100 can extract customer attributes and life changes from the stored data to use in labeling training data 122 for returning customers. Labeling the training data with the customer attributes and life changes can provide ground truth for the ML models 120. Labeled training data 122 for returning users can therefore form a second training data set comprising user profile data generated within product 20 after the login stage of operation of product 20.

At 204, system 100 can perform model training and deployment, for example of ML models 120, using labeled training data 122 obtained and/or generated at 202. The features obtained at 202 can include, for example, visitor-level features and historical tax form features. System 100 can also access ground-truth customer attribute and life change labeled data. Using this information, system 100 can build ML classification models to predict whether a user has a specific attribute or not. Also, system 100 can build multiple sets of models to deal with different situations (for example, new users as opposed to returning users), since the features available for different sets of users may be different.

In some embodiments, system 100 can build and train at least two ML models 120 per attribute being evaluated. One ML model 120 for a given attribute can be for new users, and another ML model 120 for the same attribute can be for returning users. Each attribute can map to at least one element of product 20 that can be configured. Using the tax preparation product 20 example, an attribute can indicate that the user owns a home and has a mortgage, or that the user is self-employed, or that the user has dependents, etc. Each attribute can require one or more product 20 elements, such as different tax forms or preselections within certain tax forms, depending on presence or absence of given attributes.

Thus, at 204, system 100 can receive a first training data set (e.g., labeled training data 122 for new customers) and a second training data set (e.g., labeled training data 122 for returning customers). System 100 can train a first set of ML models 120 on the first training data set, wherein each respective one of the first set of ML models 120 can be configured to predict a separate respective software product 20 element and the first set of ML models 120 is configured to collectively predict a specific set of software product 20 elements. System 100 can also train a second set of ML models 120 on the second training data set, wherein each respective one of the second set of ML models 120 can be configured to predict a separate respective software product 20 element and the second set of ML models 120 is configured to collectively predict the specific set of software product 20 elements. As such, once trained, each ML model 120 can be different. That is, an ML model 120 for a new user for a particular element can be different from an ML model 120 for a returning user for the same element, so that collectively, the first set of ML models and the second set of ML models have no ML models in common. The ML models 120 can be any known or proprietary classification models and can be trained by any known or proprietary techniques.

In some embodiments, system 100 can test the trained ML models 120 to determine how to set thresholds for classifying users during deployment. System 100 can process one or more evaluation data sets with the ML models 120 and compare the results of ML model 120 classification with the known classifications of data entries within the evaluation data sets. ML models 120 determined to be highly accurate in this way can have thresholds for classifying users during deployment set so that lower similarity levels are required to classify a user compared with ML models 120 determined to be less accurate. In any case, the specific threshold for any given ML model 120 or system 100 deployment can be a design choice in various embodiments and is not necessarily limited to a specific threshold for all embodiments.

As described below, during deployment the trained ML models 120 for the new users and returning users can be selected depending on whether a user is new or returning and then used to predict at least a subset of the specific set of software product 20 elements for the user by processing the user data with the selected ML models 120, so that product 20 can include the predicted subset of software product elements upon user access.

At 206, system 100 can perform online inference during onboarding, for example onboarding of a user of client 10 into product 20. Online inference is described in detail below with reference to the subsequent figures. To summarize, system 100 can process user data with selected ML models 120 to determine how to provision product 20. For example, at least one output of the processing of the user data with the selected set of the plurality of ML models 120 can include a respective confidence score for each respective software product 20 element, and the predicted subset of software product 20 elements can include the subset of the specific set of software product 20 elements having respective confidence scores above at least one threshold value. In some embodiments, the respective software product 20 elements can include pre-selectable elements, and the configuring can include initializing at least one of the pre-selectable elements with at least one predicted selection. In some embodiments, the respective software product elements 20 can include pre-fillable elements, and the configuring can include populating at least one of the pre-fillable elements with at least one previous value.

By performing process 200, system 100 can solve the problem of providing personalized onboarding experiences with ML models 120 that leverage customer data to provide a personalized onboarding experience for first-time customers who lack historical onboarding information from previously using product 20. System 100 can address this challenge by deriving visitor-level features through tracking user behavior on a website of product 20 before their log-ins, which can include clickstream behavior and/or external marketing campaigns that brought them to the site. System 100 can derive ground truth of customer attributes and life changes for new customers from the answers to previous new customers' onboarding questions.

At the same time, by using different ML models 120 for different customers, system 100 can solve the above problem without reducing predictive performance for returning customers, for whom there can be rich historical information for system 100 to leverage, such as previous-profile data and onboarding information. In addition, the ground truth of the customer attributes and life changes can be easier to obtain and more accurate for returning users since some of the customer attributes and life changes can be verified through their product 20 history.

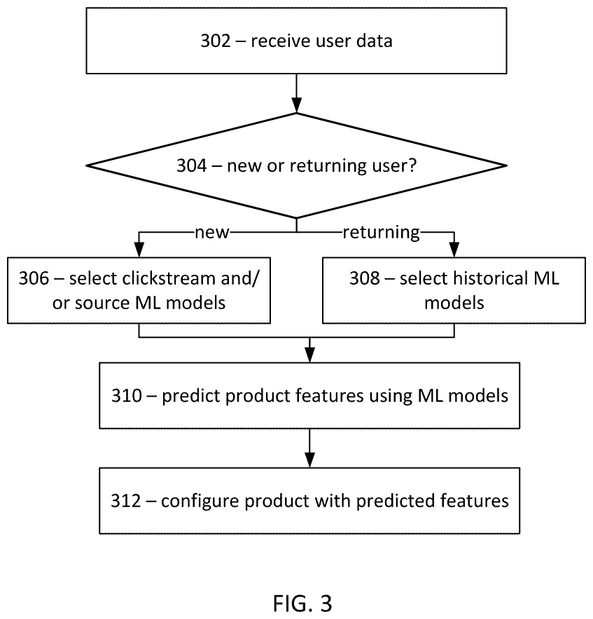

FIG. 3 shows an example personalized onboarding and product configuration process 300 according to some embodiments of the disclosure. For example, system 100 can perform process 300 at 206 of process 200 when system 100 is online and provisioned. When a user starts an onboarding process with product 20 (e.g., by requesting to sign up or by logging into an existing account), system 100 can collect their latest visitor level information and their historical information from previous visits to do model predictions. In the tax preparation example, system 100 can collect historical information such as tax information filed in previous year(s). System 100 can use the collected information to predict product 20 elements that match the user information above a confidence score threshold. In the tax preparation example, the predictions can include customer attributes and life changes related to tax situations, and the product 20 elements can be tax forms or UI features that relate to the customer attributes and life changes. Based on the predicted customer attributes and life changes, system 100 can personalize the onboarding process by preselecting those attributes with high confidence scores to accelerate the user's onboarding process and/or mapping the user to relevant product offerings and personalized messaging for a better onboarding experience. Process 300 may include advanced featurization techniques to derive highly accurate customer attributes and life changes and may select appropriate and/or relevant ML models 120 to predict whether a customer has a specific attribute or not. The use of latest customer information and/or historical data can provide a highly personalized onboarding experiences for customers while improving efficiency in the process.

At 302, system 100 can receive user data indicating the user is attempting to access product 20. For example, a user of client 10 can interact with product 20 through a UI displayed by client 10, such as a webpage or app landing screen for product 20 served to client 10 through the internet or another network, to give a non-limiting example. Activity within the UI can be captured as clickstream data 104 by any known or proprietary clickstream capture technique. In cases where the user is a returning user, product 20 can have, or have access to, stored profile data 102 of the user, which can be retrieved in response to receiving a user ID/password combination or some other identifier. User classification module 110 can obtain such profile data 102 and/or clickstream data 104 for the user of client 10.

At 304, user classification module 110 can determine a user type from the user data received at 302, for example selecting the user type as one of at least a new user and a returning user. In at least some embodiments, user classification module 110 can determine that a user is a returning user in response to profile data 102 being available for the user. In some embodiments, user classification module 110 can determine that a user is a returning user not only in response to profile data 102 being available for the user, but also in response to a completeness level of the profile data 102, or an amount of the profile data 102, being above a threshold value. User classification module 110 can classify users meeting the profile data 102 requirements (whether based on existence, completeness, amount, or some other criteria) as returning users. User classification module 110 can classify other users, such as those without profiles or with profiles having a completeness and/or data amount below the threshold level, as new users. In some embodiments, user classification module 110 can determine whether a user is new or returning from the clickstream data, for example because a new user will have a different flow through a UI than a returning user (e.g., registering an account as opposed to logging into an existing account). In such cases, user classification module 110 can compare the clickstream with expected clickstream flows of new and returning users to determine whether the user's clickstream matches an expected clickstream flow and classify the user accordingly.

Depending on user type, system 100 can select a set of the plurality of ML models 120 corresponding with the user type with which to process the data. If user classification module 110 determines the user is (or is likely to be) a new user, at 306, system 100 can select a plurality of ML models 120 configured to collectively predict a set of product 20 elements that have been trained using clickstream data and/or access source data as described above. If user classification module 110 determines the user is (or is likely to be) a returning user, at 308, system 100 can select a plurality of ML models 120 configured to collectively predict the same set of product 20 elements, but that is a different set of ML models 120 that have been trained using profile data as described above. Owing to the different training, the first set selected at 306 and the second set selected at 308 may have no ML models 120 in common, even though the first set selected at 306 and the second set selected at 308 may each be configured to collectively predict the same set of product 20 elements. That is, system 100 can select the first set and omit the second set in response to the determining selecting the user type as the new user or omit the first set and select the second set in response to the determining selecting the user type as the returning user.

At 310, system 100 can process the user data with each of the selected set of ML models 120, thereby predicting at least a subset of the product 20 elements that may be useful to the user. For each product 20 feature, the user data may be processed by a given ML model 120. Each ML model 120 can output a likelihood of the user needing its associated product 20 feature, and system 100 can determine whether or not the likelihood is above a threshold value. If the likelihood is above the threshold, system 100 can determine that the given product 20 feature should be provisioned.

At 312, product provisioning module 130 can provision product 20 to include the predicted subset of product 20 elements upon user access. In embodiments wherein the product 20 elements include pre-selectable elements, system 100 can use the predictions at 310 to predict at least one selection for at least one of the pre-selectable elements and initialize the at least one of the pre-selectable elements with the at least one predicted selection. In the tax preparation example, this can include selecting tax forms, UI elements, etc. that similar users have used in the past. In embodiments wherein the product 20 elements include pre-fillable elements, system 100 can retrieve at least one previous value for at least one of the pre-fillable elements for users who are returning users with previous values in their profile data 102, and system 100 can populate the at least one pre-fillable element with the retrieved value(s). In the tax preparation example, this can include pre-filling at least some portions of tax forms with data provided for last year's filing.

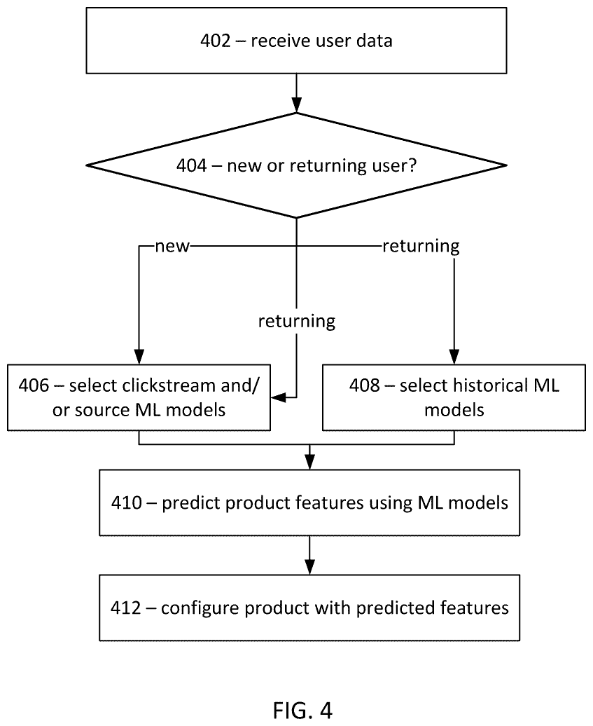

FIG. 4 shows an example personalized onboarding and product configuration process 400 according to some embodiments of the disclosure. For example, system 100 can perform process 400 at 206 of process 200 when system 100 is online and provisioned. Process 400 may be similar to process 300 in that when a user starts an onboarding process with product 20 (e.g., by requesting to sign up or by logging into an existing account), system 100 can collect their latest visitor level information and their historical information from previous visits to do model predictions. System 100 can use the collected information to predict product 20 elements that match the user information above a confidence score threshold. Based on predicted customer attributes and life changes, system 100 can personalize the onboarding process by preselecting those attributes with high confidence scores to accelerate the user's onboarding process and/or mapping the user to relevant product offerings and personalized messaging for a better onboarding experience. Process 400 may include advanced featurization techniques to derive highly accurate customer attributes and life changes and may select appropriate and/or relevant ML models 120 to predict whether a customer has a specific attribute or not. The use of latest customer information and/or historical data can provide a highly personalized onboarding experiences for customers while improving efficiency in the process.

At 402, system 100 can receive user data indicating the user is attempting to access product 20. For example, a user of client 10 can interact with product 20 through a UI displayed by client 10, such as a webpage or app landing screen for product 20 served to client 10 through the internet or another network, to give a non-limiting example. Activity within the UI can be captured as clickstream data 104 by any known or proprietary clickstream capture technique. In cases where the user is a returning user, product 20 can have, or have access to, stored profile data 102 of the user, which can be retrieved in response to receiving a user ID/password combination or some other identifier. User classification module 110 can obtain such profile data 102 and/or clickstream data 104 for the user of client 10.

At 404, user classification module 110 can determine a user type from the user data received at 402, for example selecting the user type as one of at least a new user and a returning user. In at least some embodiments, user classification module 110 can determine that a user is a returning user in response to profile data 102 being available for the user. In some embodiments, user classification module 110 can determine that a user is a returning user not only in response to profile data 102 being available for the user, but also in response to a completeness level of the profile data 102, or an amount of the profile data 102, being above a threshold value. User classification module 110 can classify users meeting the profile data 102 requirements (whether based on existence, completeness, amount, or some other criteria) as returning users. User classification module 110 can classify other users, such as those without profiles or with profiles having a completeness and/or data amount below the threshold level, as new users. In some embodiments, user classification module 110 can determine whether a user is new or returning from the clickstream data, for example because a new user will have a different flow through a UI than a returning user (e.g., registering an account as opposed to logging into an existing account). In such cases, user classification module 110 can compare the clickstream with expected clickstream flows of new and returning users to determine whether the user's clickstream matches an expected clickstream flow and classify the user accordingly.

Depending on user type, system 100 can select a set of the plurality of ML models 120 corresponding with the user type with which to process the data. For both new users and returning users, at 406, system 100 can select a plurality of ML models 120 configured to collectively predict a set of product 20 elements that have been trained using clickstream data and/or access source data as described above. If user classification module 110 determines the user is (or is likely to be) a returning user, at 408, system 100 can select a plurality of ML models 120 configured to collectively predict the same set of product 20 elements, but that is a different set of ML models 120 that have been trained using profile data as described above. Thus, new user data can be processed by the first set of ML models 120 as selected at 406, while returning user data can be processed by a combination of the first set of ML models 120 as selected at 406 and the second set of ML models 120 as selected at 408. In this embodiment, new user data and returning user data can be processed by some ML models 120 in common, but the total set of ML models 120 for new users can be different from the total set of ML models 120 for returning users.

At 410, system 100 can process the user data with each of the selected set of ML models 120, thereby predicting at least a subset of the product 20 elements that may be useful to the user. For each product 20 feature, the user data may be processed by a given ML model 120. Each ML model 120 can output a likelihood of the user needing its associated product 20 feature, and system 100 can determine whether or not the likelihood is above a threshold value. If the likelihood is above the threshold, system 100 can determine that the given product 20 feature should be provisioned.

At 412, product provisioning module 130 can provision product 20 to include the predicted subset of product 20 elements upon user access. In embodiments wherein the product 20 elements include pre-selectable elements, system 100 can use the predictions at 410 to predict at least one selection for at least one of the pre-selectable elements and initialize the at least one of the pre-selectable elements with the at least one predicted selection. In the tax preparation example, this can include selecting tax forms, UI elements, etc. that similar users have used in the past. In embodiments wherein the product 20 elements include pre-fillable elements, system 100 can retrieve at least one previous value for at least one of the pre-fillable elements for users who are returning users with previous values in their profile data 102, and system 100 can populate the at least one pre-fillable element with the retrieved value(s). In the tax preparation example, this can include pre-filling at least some portions of tax forms with data provided for last year's filing.

Regardless of whether a user is a new customer or a returning customer, in both process 300 and process 400 system 100 can use multiple ML models 120 to predict whether the customer have an attribute or not. Predicted attributes with high confidence scores can trigger preselection to accelerate user onboarding processing and/or mapped to relevant product 20 offerings and personalized messaging during the onboarding process. Overall, system 100 can provide a more tailored and engaging onboarding experience, leading to lower churn and increased customer satisfaction, while increasing operational efficiency and ML prediction accuracy.

FIG. 5 shows a computing device 500 according to some embodiments of the disclosure. For example, computing device 500 may function as system 100 or any portion(s) thereof, or multiple computing devices 500 may function as system 100.

Computing device 500 may be implemented on any electronic device that runs software applications derived from compiled instructions, including without limitation personal computers, servers, smart phones, media players, electronic tablets, game consoles, email devices, etc. In some implementations, computing device 500 may include one or more processors 502, one or more input devices 504, one or more display devices 506, one or more network interfaces 508, and one or more computer-readable mediums 510. Each of these components may be coupled by bus 512, and in some embodiments, these components may be distributed among multiple physical locations and coupled by a network.

Display device 506 may be any known display technology, including but not limited to display devices using Liquid Crystal Display (LCD) or Light Emitting Diode (LED) technology. Processor(s) 502 may use any known processor technology, including but not limited to graphics processors and multi-core processors. Input device 504 may be any known input device technology, including but not limited to a keyboard (including a virtual keyboard), mouse, track ball, and touch-sensitive pad or display. Bus 512 may be any known internal or external bus technology, including but not limited to ISA, EISA, PCI, PCI Express, NuBus, USB, Serial ATA or FireWire. In some embodiments, some or all devices shown as coupled by bus 512 may not be coupled to one another by a physical bus, but by a network connection, for example. Computer-readable medium 510 may be any medium that participates in providing instructions to processor(s) 502 for execution, including without limitation, non-volatile storage media (e.g., optical disks, magnetic disks, flash drives, etc.), or volatile media (e.g., SDRAM, ROM, etc.).

Computer-readable medium 510 may include various instructions 514 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 504; sending output to display device 506; keeping track of files and directories on computer-readable medium 510; controlling peripheral devices (e.g., disk drives, printers, etc.) which can be controlled directly or through an I/O controller; and managing traffic on bus 512. Network communications instructions 516 may establish and maintain network connections (e.g., software for implementing communication protocols, such as TCP/IP, HTTP, Ethernet, telephony, etc.).

System 100 components 518 may include instructions for performing the processing described herein. For example, system 100 components 518 may provide instructions for performing any and/or all of process 200, process 300, process 400, and/or other processing as described above. Application(s) 520 may be an application that uses or implements the outcome of processes described herein and/or other processes. In some embodiments, the various processes and/or portions thereof may also be implemented in operating system 514.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In some cases, instructions, as a whole or in part, may be in the form of prompts given to a large language model or other machine learning and/or artificial intelligence system. As those of ordinary skill in the art will appreciate, instructions in the form of prompts configure the system being prompted to perform a certain task programmatically. Even if the program is non-deterministic in nature, it is still a program being executed by a machine. As such, “prompt engineering” to configure prompts to achieve a desired computing result is considered herein as a form of implementing the described features by a computer program.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API and/or SDK, in addition to those functions specifically described above as being implemented using an API and/or SDK. An API may define one or more parameters that are passed between a calling application and other software code (e.g., an operating system, library routine, function) that provides a service, that provides data, or that performs an operation or a computation. SDKs can include APIs (or multiple APIs), integrated development environments (IDEs), documentation, libraries, code samples, and other utilities.

The API and/or SDK may be implemented as one or more calls in program code that send or receive one or more parameters through a parameter list or other structure based on a call convention defined in an API and/or SDK specification document. A parameter may be a constant, a key, a data structure, an object, an object class, a variable, a data type, a pointer, an array, a list, or another call. API and/or SDK calls and parameters may be implemented in any programming language. The programming language may define the vocabulary and calling convention that a programmer will employ to access functions supporting the API and/or SDK.

In some implementations, an API and/or SDK call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method comprising:
receiving, by at least one processor, user data indicating a user attempt to access a software product;
determining, by the at least one processor, a user type from the user data, the determining comprising selecting the user type as one of at least a new user and a returning user;
selecting, by the at least one processor, a set of a plurality of machine learning (ML) models corresponding with the user type with which to process the data, wherein:
each respective one of the plurality of ML models is configured to predict a separate respective software product element,
a first set of the plurality of ML models comprises ML models configured to collectively predict a specific set of software product elements,
a second set of the plurality of ML models comprises ML models configured to collectively predict the specific set of software product elements, and
the first set and the second set have no ML models in common,
the selecting comprising selecting the first set and omitting the second set in response to the determining selecting the user type as the new user or selecting the first set and the second set in response to the determining selecting the user type as the returning user;
predicting, by the at least one processor, at least a subset of the specific set of software product elements for the user by processing the user data with the selected set of the plurality of ML models; and
configuring, by the at least one processor, the software product to include the predicted subset of software product elements upon user access.

2. The method of claim 1, wherein:
each respective ML model of the first set of the plurality of ML models is trained on clickstream data;
the user data comprises user clickstream data; and
the predicting comprises processing the user clickstream data with the first set of the plurality of ML models.

3. The method of claim 1, wherein:
each respective ML model of the second set of the plurality of ML models is trained on past user profile data;
the user data comprises user profile data; and
the predicting comprises processing the user profile data with the second set of the plurality of ML models.

4. The method of claim 1, wherein:
the respective software product elements comprise pre-selectable elements;
the predicting comprises predicting at least one selection for at least one of the pre-selectable elements; and
the configuring comprises initializing the at least one of the pre-selectable elements with the at least one predicted selection.

5. The method of claim 1, wherein:
the respective software product elements comprise pre-fillable elements;
the predicting comprises retrieving at least one previous value for at least one of the pre-fillable elements in response to the determining selecting the user type as the returning user; and
the configuring comprises populating the at least one of the pre-fillable elements with the at least one previous value.

6. The method of claim 1, wherein:
at least one output of the processing of the user data with the selected set of the plurality of ML models comprises a respective confidence score for each respective software product element; and
the predicting comprises selecting the subset of the specific set of software product elements having respective confidence scores above at least one threshold value.

7. The method of claim 1, wherein receiving the user data comprises at least one of:
generating clickstream data within the software product prior to a login;
determining a route by which the software product was initially accessed by the user; and
retrieving stored user profile data.

8. A method comprising:
receiving, by at least one processor, user data indicating a user attempt to access a software product;
determining, by the at least one processor, a user type from the user data, the determining comprising selecting the user type as one of at least a new user and a returning user;
selecting, by the at least one processor, a set of a plurality of machine learning (ML) models corresponding with the user type with which to process the data, wherein:
each respective one of the plurality of ML models is configured to predict a separate respective software product element,
a first set of the plurality of ML models corresponds with the new user and comprises ML models configured to collectively predict a specific set of software product elements,
a second set of the plurality of ML models corresponds with the returning user and comprises ML models configured to collectively predict the specific set of software product elements, and
the first set and the second set have no ML models in common,
the selecting comprising selecting the first set in response to the determining selecting the user type as the new user or selecting the second set in response to the determining selecting the user type as the returning user;
predicting, by the at least one processor, at least a subset of the specific set of software product elements for the user by processing the user data with the selected set of the plurality of ML models; and
configuring, by the at least one processor, the software product to include the predicted subset of software product elements upon user access.

9. The method of claim 8, wherein:
each respective ML model of the first set of the plurality of ML models is trained on clickstream data;
the user data comprises user clickstream data; and
the predicting comprises processing the user clickstream data with the first set of the plurality of ML models.

10. The method of claim 8, wherein:
each respective ML model of the second set of the plurality of ML models is trained on past user profile data;
the user data comprises user profile data; and
the predicting comprises processing the user profile data with the second set of the plurality of ML models.

11. The method of claim 8, wherein:
the respective software product elements comprise pre-selectable elements;
the predicting comprises predicting at least one selection for at least one of the pre-selectable elements; and
the configuring comprises initializing the at least one of the pre-selectable elements with the at least one predicted selection.

12. The method of claim 8, wherein:
the respective software product elements comprise pre-fillable elements;
the predicting comprises retrieving at least one previous value for at least one of the pre-fillable elements in response to the determining selecting the user type as the returning user; and
the configuring comprises populating the at least one of the pre-fillable elements with the at least one previous value.

13. The method of claim 8, wherein:
at least one output of the processing of the user data with the selected set of the plurality of ML models comprises a respective confidence score for each respective software product element; and
the predicting comprises selecting the subset of the specific set of software product elements having respective confidence scores above at least one threshold value.

14. The method of claim 8, wherein receiving the user data comprises at least one of:
generating clickstream data within the software product prior to a login;
determining a route by which the software product was initially accessed by the user; and
retrieving stored user profile data.

15. A method comprising:
receiving, by at least one processor, a first training data set comprising clickstream data generated within a software product prior to a login stage of operation of the software product;
receiving, by the at least one processor, a second training data set comprising user profile data generated within the software product after the login stage of operation of the software product;
training, by the at least one processor, a first set of machine learning (ML) models on the first training data set, wherein each respective one of the first set of ML models is configured to predict a separate respective software product element and the first set of ML models is configured to collectively predict a specific set of software product elements; and
training, by the at least one processor, a second set of ML models on the second training data set, wherein each respective one of the second set of ML models is configured to predict a separate respective software product element and the second set of ML models is configured to collectively predict the specific set of software product elements;
wherein the trained first set of ML models and the trained second set of ML models are selectable, in response to user data indicating a user attempt to access the software product, in accordance with a user type determined from the user data and operable to predict at least a subset of the specific set of software product elements for the user by processing the user data with a selected set of the plurality of ML models, and wherein the software product is configured to include the predicted subset of software product elements upon user access.

16. The method of claim 15, wherein the first training data set further comprises information describing routes by which the software product was initially accessed by users.

17. The method of claim 15, wherein, after the training of the first set of ML models and the training of the second set of ML models, the first set of ML models and the second set of ML models have no ML models in common.

18. The method of claim 15, wherein:
at least one output of the processing of the user data with the selected set of the plurality of ML models comprises a respective confidence score for each respective software product element; and
the predicted subset of software product elements comprises the subset of the specific set of software product elements having respective confidence scores above at least one threshold value.

19. The method of claim 15, wherein:
the respective software product elements comprise pre-selectable elements; and
the configuring comprises initializing at least one of the pre-selectable elements with at least one predicted selection.

20. The method of claim 15, wherein:
the respective software product elements comprise pre-fillable elements; and
the configuring comprises populating the at least one of the pre-fillable elements with at least one previous value.
